(19) United States
(12) Patent Application Publication
(10) Pub. No.: US 2024/0140248 A1
(43) Pub. Date: May 2, 2024

(54) METHOD FOR CHARACTERIZING ENERGY STORED IN A VEHICLE, CHARGING DEVICE, CONTROL UNIT AND VEHICLE

(71) Applicant: ZF Friedrichshafen AG, Friedrichshafen (DE)

(72) Inventors: Stephan Demmerer, Wasserburg (Bodensee) (DE); Christian Gürlich, Ravensburg (DE); Otmar Scharrer, Esslingen am Neckar (DE); Gerhard Müller, Immenstaad am Bodensee (DE); Johannes Ochsenreiter, Kressbronn (DE)

(73) Assignee: ZF Friedrichshafen AG, Friedrichshafen (DE)

(21) Appl. No.: 18/495,465

(22) Filed: Oct. 26, 2023

(30) Foreign Application Priority Data
Oct. 26, 2022 (DE) 102022211355.1

(51) Int. Cl. B60L 53/66; B60L 55/00

(52) U.S. Cl. CPC B60L 53/66; B60L 55/00

(57) ABSTRACT

A method for characterizing energy stored in a vehicle, where the energy is delivered from an energy source to an energy store of the vehicle, the method includes acquiring information on energy supplied, processing information on the energy in order to establish an energy class of the energy, and assigning the energy that is delivered to the energy store to an energy class. A charging device, a control unit, and a vehicle are also disclosed.

### CROSS-REFERENCE TO RELATED APPLICATION

This application claims priority to German Application No. DE 10 2022 211 355.1, filed on Oct. 26, 2022, the entirety of which is hereby fully incorporated by reference herein.

### FIELD

The present invention relates to a method for characterizing energy stored in a vehicle, a charging device for the delivery of energy to an energy store of a vehicle, a control unit for a vehicle having an energy store, and a vehicle.

### BACKGROUND

Electric vehicles or plug-in hybrid vehicles require charging at charging points (such as, for example, charging columns or wall boxes). Electricity is thus made available by an electricity supplier. However, an electricity customer will not immediately be aware of whether or not the electricity supplied is green electricity. Electricity supplied, depending upon the prevailing local electricity mix, is associated with a CO2 footprint expressed in gCO2/kWh. For the calculation of a CO2 footprint of a vehicle and the components thereof, an average value for the electricity mix of a country or a region is customarily assumed. This occurs frequently, even if charging is executed exclusively using solar power or green electricity. The energy balance for the manufacture and use of such a vehicle is thus determined on a flat-rate basis by the application of an averaged electricity mix and, in consequence, is frequently very high, notwithstanding the fact that, in reality, a more favorable electricity mix is available for charging. This issue applies not only to electric power, but also to other primary and/or secondary energy sources such as, for example, hydrogen. Here again, distinctions are drawn between the CO2 footprint of green hydrogen, blue hydrogen, turquoise hydrogen, etc.

### SUMMARY

An object of the present invention is therefore the characterization of the energy take-up of a vehicle and, on the basis thereof, to permit an environment-friendly control of the vehicle and, moreover, to provide an accurate CO2 footprint calculation.

This object is fulfilled by a method for characterizing energy which is stored in a vehicle having the features disclosed herein, by a charging device for the delivery of energy to an energy store of a vehicle having the features disclosed herein, by a control unit for a vehicle with an energy store having the features disclosed herein, and by a vehicle having the features disclosed herein.

According to one aspect of the present invention, a method is provided for characterizing energy which is stored in a vehicle, wherein energy is delivered from an energy source to an energy store of the vehicle, wherein the method comprises the following: acquisition of information on energy supplied, processing of information on energy, in order to establish an energy class of this energy, and the assignment to an energy class of energy which is delivered to the energy store.

In comparison with the known prior art, the present invention provides an advantage, in that energy which is stored in an energy store is characterized, and the resulting CO2 footprint associated with the operation of the vehicle using energy which is stored in the energy store is thus known. Thus, on the one hand, over the entire service life of the vehicle, information can be acquired with respect to the exact present or previous size of the CO2 footprint of the vehicle. Moreover, various functionalities, internally and/or externally to the vehicle, can be controlled on the basis of the CO2 footprint (for example, on the basis of the energy class) of energy which is stored in the energy store.

Energy can be a primary and/or secondary energy source. For example, energy can be electrical energy, which can drive an electric motor. Moreover, the energy source can also be hydrogen, which can be delivered to an energy store, and subsequently converted into electrical energy in a fuel cell. The focus of the present embodiment is the assignment of energy to a particular classification. Energy can thus be classified, for example, according to the manner in which it has been generated. Electric power can be generated, for example, in a coal-fired or gas-fired power plant, such that electricity is already associated with the production of a certain quantity of CO2 (i.e. has a CO2 footprint). This is the “CO2 footprint” (i.e. the quantity of CO2 generated by energy from its production through to the time point considered). Conversely, “green electricity” can be generated, for example from solar, wind and/or water power, which assumes a smaller CO2 footprint, in comparison with electricity produced from coal or gas. It is further conceivable that the energy source can also be a gas. Gas can be generated in biogas plants (i.e. in an eco-friendly manner), or can be conveyed from natural sources. Thus, a particular CO2 footprint can also be assigned to a gas.

The energy source can be, for example, a charging point for energy (e.g. electric power, hydrogen or other forms of energy). It is of no consequence whether the energy source is privately or publicly operated. The energy source, for example, can be connected to an energy distribution network. The energy store can be a store which can store energy over a period of time. For example, an energy store can be an accumulator or a tank.

Information on energy delivered can be acquired, for example, via a data line which is provided between the energy store and the energy source. The energy source can be directly connected to the energy store, or indirectly connected (for example via a charging device) to the energy store. Communication of this type, for example, can be executed by means of existing communication links. Information, for example with respect to energy sources of private households, can be defined under the terms of a specific supply contract, for example an electricity supply contract. In the case of publicly accessible energy sources, information on available energy, for example, can be dynamically updated by an energy supplier. It is, moreover, conceivable for information on energy delivered to be transmitted wirelessly. To this end, information can be retrieved from a central memory. Information can include, for example, the manner in which energy has been generated. Information on energy delivered can include disclosure of the CO2 footprint associated with energy delivered. For example, information can define whether electric power supplied is green electricity (i.e. electricity generated from renewable energy sources) or otherwise. Processing of information can include the assignment of energy delivered to standardized classes (i.e. energy classes). Information on energy delivered can thus indicate, for example, that electricity delivered has been generated by means of water power. From the processing of information on energy, it can proceed that energy thus delivered is assigned to the “green electricity” energy class. Thus, by the processing of information, a uniform characterization or designation of energy can be achieved. A uniform designation of this type can then be an energy class, to which the energy delivered is assigned. As indicated above, one energy class can be described as “green energy”, to which any energy which is generated from renewable sources is assigned. Renewable energy sources can be defined by a specific CO2 footprint of energy. Moreover, a further energy class can be provided, described as “undefined energy”, to which any energy is assigned, the form of generation (and thus the CO2 footprint) of which is not known, or which exceeds a specific CO2 footprint threshold value. This provides an advantage, in that a simple assignment of energy classes is permitted, and a distinction between different forms of energy can be drawn in a simple manner. Moreover, a further subdivision can be executed, for example on the basis of the CO2 footprint of the respective energy. Thus, for example, different quantity ranges of CO2 emissions (gCO2) can be defined and, on the basis thereof, energy assigned to a specific energy class. Further subclasses can thus be formed within the “green energy” class. By the assignment of energy to different energy classes, energy which is stored in an energy store can be characterized. Thus, for example, the percentage to which a battery or a store is filled with green energy (for example, green electricity) can be determined. An accurate life cycle assessment of a vehicle, or of vehicle operation, can thus be executed using accurate data on the in-service CO2 footprint of the vehicle.

Preferably, the method further comprises the following: take-up of an offset instruction and alteration of the energy class of energy delivered, on the basis of the offset instruction. The offset instruction can be initiated by a user of the vehicle, or by a third party. By means of the offset instruction, the energy class of energy present in the store can be modified. Thus, for example, a quantity of energy which has previously been designated as “undefined energy” can be assigned to the “green energy” class. The offset instruction can be achieved, for example, wherein a user of the vehicle purchases and/or acquires GHG quotas (i.e. greenhouse gas reduction quotas), instructs the planting of trees, instructs rainforest conservation measures, or executes other nature conservation projects. In other words, the CO2 footprint of energy which is stored in energy stores can be reduced or offset by measures, for example by the absorption of CO2. This can be executed, for example, through the agency of an external provider, from whom the user purchases such offsetting measures, whereafter the third party then issues an offset instruction, such that the energy class of energy which is stored in the energy store is modified. It is thus possible to offset the CO2 footprint of the energy mix which is stored in the energy store, thereby reducing the CO2 footprint associated with the operation of the vehicle. This provides an advantage in that, in the event that no green energy is available for charging a vehicle, the CO2 footprint thereof can nevertheless be offset or reduced. Using information on energy supplied, it is further possible to obtain more accurate information on the CO2 footprint, such that any offsetting thereof can be executed in a more accurate and targeted manner.

The method preferably comprises an output of information on the energy class of energy delivered. In other words, the type of energy which is stored in the energy store can delivered as an information output to a third party and/or to the user of the vehicle. As a result, the user of the vehicle can receive dynamic information on the current status of their energy consumption or CO2 footprint. Moreover, further functionalities can be associated with the type of energy which is stored in the energy store. For example, on motorways or on other roads, a variable toll can be levied, depending upon whether a vehicle assumes a small CO2 footprint or a large CO2 footprint. A facility for exemption from tolls (for example, a city toll) might also be provided, which is then applied if energy stored in the energy store is of a specific energy class (for example, “green energy”). Moreover, for example in a city, a vehicle might only be permitted to drive at a maximum power or speed if the energy employed for this purpose is assigned to a specific energy class (for example, “green energy”). It is moreover conceivable that a vehicle will only be permitted to enter a city, or to use specific parking spaces or parking garages, if it does not exceed a specific CO2 footprint (i.e. the energy in the energy store is assigned to a specific energy class). In other words, specific areas or functionalities might only be accessible to the user and the vehicle, if the energy contained in the energy store is assigned to a specific energy class. Moreover, parking charges might be subject to a percentage increase, if the vehicle is not entirely operated using CO2-neutral energy within a specific area, for example in an urban zone. Energy which is present in the energy store, and/or which is consumed in a specific time period or in a specific region, can be considered for this purpose. By means of known information on energy which is stored and consumed, functions of this type can be realized with no further action. To this end, an information output can be generated by a standardized query between the vehicle and external recipients.

Information on energy can preferably include information on the CO2 footprint of energy. In other words, information on energy can include a record of the quantity of CO2 which has been emitted for the generation and/or transmission of said energy. The CO2 footprint can thus be communicated by reference to information on energy, in particular simultaneously, or in tandem with a charging process.

Preferably, the method further comprises the following: outputting of control commands on the basis of the energy class of energy delivered. In other words, an output of control commands can be generated on the basis of the energy class of energy which is saved in the energy store. Control commands can be commands which control the operation of the vehicle. In particular, control commands can enable or inhibit specific functionalities of the vehicle. It can thus be achieved, for example, that the vehicle can only deploy its full potential power, if the energy in the energy store employed for this purpose is assigned to a specific energy class (for example, “green energy”). In the event that the green energy component of the energy store is exhausted, and further energy is only available from non-CO2-free or non-CO2-neutral sources, control commands can limit functionalities such as, for example, the maximum available power of the vehicle. An incentive can thus be provided for the user of the vehicle to supply the energy store with energy of a particular energy class. Moreover, an incentive can thus be provided to offset non-CO2-neutral energy in the energy store by means of the above-mentioned offsetting system. In particular, by means of control commands, a control can be executed to the effect that the vehicle can only be operated up to its maximum speed, if the energy contained in the energy store is assigned to a specific energy class. If energy in the green energy class is exhausted, it will only be possible for the vehicle to operate up to a specified maximum speed, for example of 100 km/h on a motorway or 80 km/h on intercity roads. A targeted initiative can thus be directed to the effect that CO2-neutral energy is delivered to the energy store, or that other forms of energy are offset by means of the offsetting process.

According to a further aspect of the present invention, a charging device is provided for delivering energy to an energy store of a vehicle, wherein the charging device comprises the following: an input terminal for the take-up of energy from an energy source, an output terminal for relaying energy to an energy store, and a control unit, which is configured to control the energy flux and to execute the method according to one of the above-mentioned configurations. The charging device can be an external apparatus (i.e. having a dedicated housing), or a charging device which is integrated in a vehicle. The charging device can be an AC charging device, which is provided in-vehicle, or a DC charging device, which is provided in the form of an external apparatus. The charging device, in accordance with the above-mentioned method, can deliver an output of information on energy which is transmitted via the charging device. For example, the charging device can acquire information from the charging point or energy supplier (in a hard-wired or wireless arrangement), which is then relayed to a control unit in the vehicle (for example, an ECU). The charging device can thus be configured to assign energy which is relayed via the charging device to a specific energy class. A retrofittable apparatus can thus be provided in the form of a charging device, by means of which a CO2 footprint of energy which is delivered to an energy store can be determined.

The charging device is preferably configured such that energy can be relayed bidirectionally. Energy can thus be conducted from the energy source to the energy store, but also in the opposite direction. It can thus be possible, during the daytime, for a vehicle to execute the take-up of energy of a specific energy class (for example, “green energy”) in the energy store (i.e. for the daytime charging of the vehicle with green energy). Energy in the energy store which is assigned to a specific energy class (for example, “green energy”) can then be released at night, for example to a residential property. As a result, not only can the operation of the vehicle be configured in a CO2-neutral manner (i.e. by offsetting), but it is also possible to offset CO2 which has been expended during the manufacture of the vehicle. Further incentives are thus provided for the delivery of energy of a specific energy class to the energy store. Moreover, the overall energy balance of the vehicle can be improved.

The control unit is preferably configured to control any relaying of energy on the basis of information regarding energy. In other words, the control unit can be configured such that energy is only delivered to the energy store if said energy assumes a specific energy class. In other words, in this case, the characterization of energy which is to be delivered to the energy store occurs externally to the energy store such that, prior to the delivery of energy to the energy store, a check can be executed as to whether the delivery of this energy to the energy store is or is not permitted. In this case, the control unit can evaluate which energy class applies, and can then decide whether this energy is to be delivered to the energy store. This provides an advantage in that a user, by means of a switch or a setting operation, can enable only the delivery of energy of a specific energy class to the energy store. It can thus be ensured that the energy store is only supplied with energy of a corresponding energy class, which is consistent with the intent of a user. A user can decide, for example, that their vehicle, or the energy store of their vehicle is only to be charged using green energy (e.g. green electricity). This can be regulated by the control unit of the charging device and, immediately no further green electricity is available, any further charging of the energy store is likewise interrupted. It can thus be ensured that the energy store, in accordance with the wishes of the user, is only charged using a specific energy of a particular energy class.

According to a further aspect of the present invention, a control unit is provided for a vehicle having an energy store, wherein the control unit is configured to execute the above-mentioned method. The control unit can be a separate control unit, which is configured solely for the execution of the above-mentioned method, or can be a control unit which is already installed in the vehicle, and which further assumes other control functions in the vehicle. The vehicle can be an electric vehicle, a hybrid vehicle or a hydrogen-powered vehicle. The control unit is preferably connected to other components of the vehicle via a CAN-bus.

The control unit is preferably configured to control the vehicle on the basis of the energy class of stored energy. It can thus be achieved that the vehicle will only be able to deploy the full extent of its potential power (i.e. its dynamic tractive power and/or other functionalities) if the energy for this purpose, which is sourced either directly or indirectly from the energy store, is assigned to a specific energy class. For example, it is possible that some functionalities and/or capacities will only be released if the energy stored in the energy store corresponds to the “green energy” class.

The control unit is preferably configured to deliver an output of the energy class of stored energy to the user of the vehicle. In other words, the energy class of energy which is stored in the energy store can be dynamically indicated to the user, for example by means of a display. The user can thus be notified, for example, not only of the current state-of-charge in general, but also of which form of energy is assigned to which energy class. The user can thus monitor how and whether an offsetting process is required and/or has been successfully completed. The user can further incorporate this information into the planning of their driving route. The user can thus assume an active influence over the CO2 footprint of their vehicle and its operating performance.

According to a further aspect of the present invention, a vehicle is provided, in particular an electric vehicle or a hybrid vehicle, having a control unit according to one of the above-mentioned configurations and/or having a charging device according to one of the above-mentioned configurations. In other words, the vehicle can comprise both the control unit and the charging device. The vehicle can also be a hydrogen-powered vehicle.

Individual features or embodiments can be combined with other features or other embodiments, thus forming new embodiments. These new embodiments will then assume the properties and advantages assigned to said other features or embodiments. All configurations and advantages disclosed in conjunction with the method shall apply, in an analogous manner, to the device, and vice versa.

Embodiments of the present invention are described in detail hereinafter, with reference to the attached figures.

### BRIEF DESCRIPTION OF THE DRAWINGS

FIG. 1 shows a schematic view of a vehicle according to one embodiment of the present invention.

FIG. 2 shows a schematic view of an energy store according to one embodiment of the present invention.

FIG. 3 shows a schematic view of an energy store according to one embodiment of the present invention.

FIG. 4 shows a schematic representation of a vehicle according to a further embodiment of the present invention.

FIG. 5 shows a flow diagram of a method according to one embodiment of the present invention.

### DETAILED DESCRIPTION

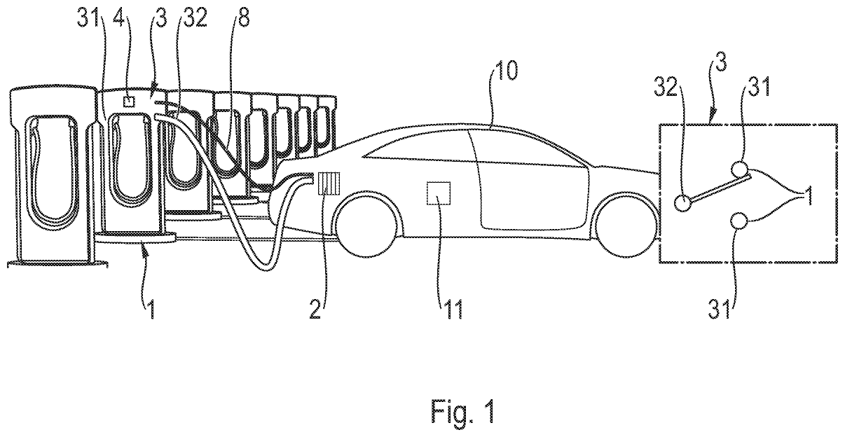

FIG. 1 shows a schematic view of a vehicle 10 which is executing a take-up of energy from an energy source 1 via a charging device 3. In the present case, the vehicle 10 is an electric vehicle, having an energy store 2 in the form of an accumulator. In the present case, the charging device 3 is configured in the form of a charging point, also described as a charging column, and comprises a connection to a power grid (i.e. an input terminal 31) and an output terminal 32, to which the vehicle 10 is connected. The charging device 3 further comprises a control unit 4, which is configured such that it can control a current flux between the energy source 1 and the energy store 2 of the vehicle 10. Additionally, a data transmission line 8 is schematically represented. This data transmission line 8 is configured to describe information with regard to energy which is delivered to the energy store 2 of the vehicle 10. In other words, via the data line 8, information on energy delivered is acquired. The charging device 3 is thus notified, for example by a grid system operator, of the type of electricity which is currently available for charging an energy store. The control unit 4 of the charging device 3 can thus acquire information on energy delivered. Moreover, the control unit 4 of the charging device can process information on energy, in order to determine or acquire an energy class of energy. This energy class is then assigned to the electricity which is supplied to the vehicle 10. The energy class of energy which is currently employed for charging can thus be communicated to the vehicle by the control unit 4 of the charging device 3. Alternatively or additionally, a control unit 11 or vehicle control unit can be provided in the vehicle 10, which acquires information on energy delivered. In this case, the control unit 11 of the vehicle 10 can determine the energy class of energy delivered, and execute the assignment of energy stored in the energy store 2. In other words, the charging device 3 and/or the vehicle 10 can execute the method for characterizing stored energy.

On the right-hand side of FIG. 1, a schematic and simplified circuit is represented. This circuit can be located in the charging device 3. At the right-hand side of the representation according to FIG. 1, a power source is connected, which can supply electric power. A take-up of electric power is executed at the input terminals 31. One input terminal can supply only green electricity, whereas the other input terminal can supply an unspecified electricity mix, or conventionally generated electricity. The control unit 4 is configured such that it can execute a decision as to whether only electricity of a specific energy class is to be relayed, or whether any type of electricity can be relayed. In the setting represented in FIG. 1, only electricity is relayed which is classified as green electricity (i.e. electricity, the generation of which produces little or no CO2). In other words, in the setting represented (i.e. with the switch in the upward setting), only green electricity is accepted, whereas conventionally generated electricity is not delivered to the energy store. A circuit of this type, as per the above example, can be arranged in the charging column 3 and/or in the vehicle 10. In the latter case, control can then be assumed by the control unit 11 of the vehicle 10.

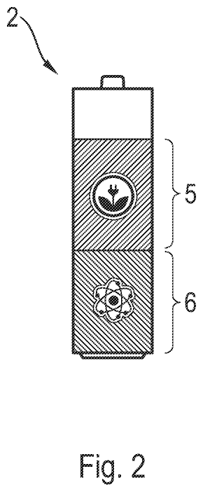

FIG. 2 shows a schematic representation of an energy store 2. In the present case, the energy store is approximately 80% charged. However, the energy with which the energy store 2 is charged is subdivided into two different energy classes 5, 6. The upper section of energy stored in the energy store 2 is identified by the reference number 5 and, in the present example, is defined as green electricity. The lower section of energy stored in the energy store 2 is identified by the reference number 6 and, in the present case, is designated as undefined electricity. Thus, in the present example, energy in the energy store 2 is subdivided into two energy classes, namely, green electricity and undefined electricity. Provided that green electricity 5 is present in the energy store 2, the vehicle 10, in the present embodiment, is operable with all functionalities and at full driving power. However, immediately the green electricity 5 in the energy store 2 is exhausted, and only undefined electricity 6 is available, only driving with limited power will be possible (for example, in an eco-mode).

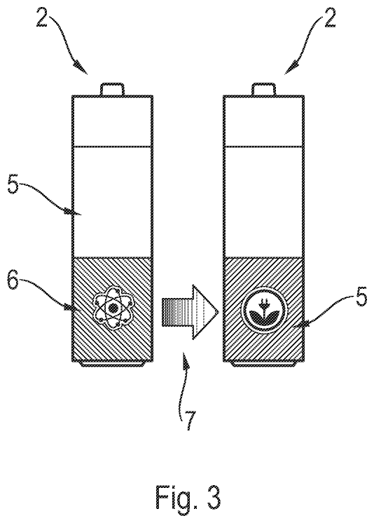

FIG. 3 shows a schematic representation of an energy store 2, in which the green electricity component 5 is entirely exhausted. In this case, as described above, the vehicle 10 can only continue to be driven with reduced power. To this end, however, an offset instruction 7 can be employed, in order to execute a switchover of the energy class to undefined electricity 6. To this end, customary and known offsetting processes can be employed for the generation of an offset instruction 7. To this end, for example, GHG quotas can be purchased, trees planted and/or rainforest conservation measures implemented. The energy class of undefined electricity in the energy store 2 can then be altered, such that only green electricity 5 is present in the energy store 2 (see right-hand representation in FIG. 3). In consequence, the full functionalities and full driving power of the vehicle will again be deployable.

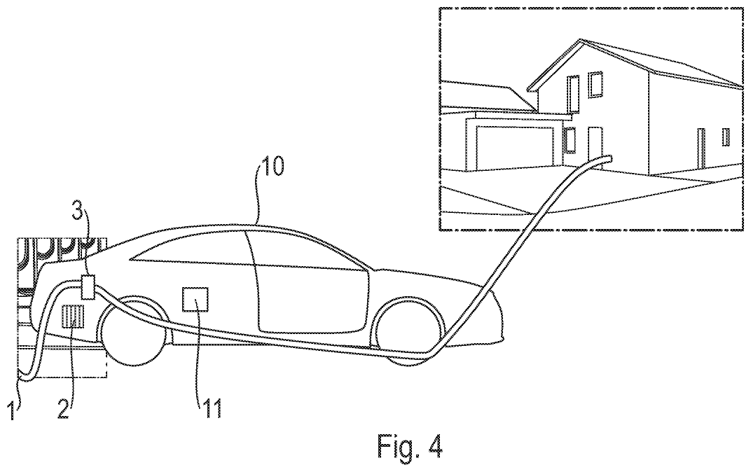

FIG. 4 shows a schematic representation of a further embodiment of the present invention. In the present embodiment, the energy store 2 of the vehicle 10 is fully charged with green electricity 5. In the present case, the control unit 11 of the vehicle 10 can control the relaying of energy, such that the vehicle delivers electricity to a house. It can thus be achieved that a vehicle 10 which is fully charged with green electricity delivers the latter to a house, for example during the night, and thus at least partially covers the power demand of the house. In other words, a bidirectional charging of the vehicle 10 can be permitted. Thus, even quantities of CO2 associated with the manufacture of the vehicle can be offset. Overall, the life cycle assessment of the vehicle can thus be significantly improved as a result.

This functionality can not only be controlled by the control unit 11 of the vehicle 10, but can also be controlled by the control unit 4 of the charging device 3.

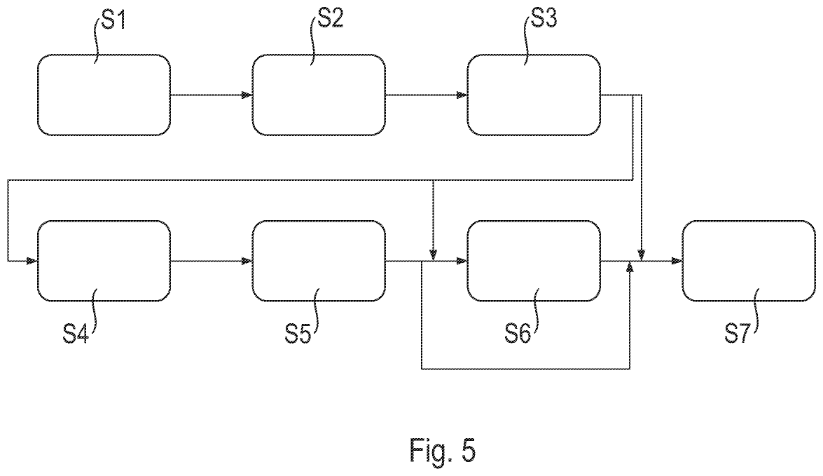

FIG. 5 shows a schematic flow diagram, which represents the sequence of a method according to one embodiment of the present invention. In step S1, information on energy delivered to an energy store 2 is acquired. This information is processed in step S2, in order to establish an energy class of energy. In other words, in step S2, the footprint of energy is determined. In step S3, the energy class which has previously been determined in step S2 is assigned to the energy which is stored in the energy store 2. In other words, in step S3, it is determined which component of energy in the energy store 2 assumes which energy class. During the consumption of energy from the energy store 2, energy of the most environment-friendly energy class (i.e. with no, or virtually no CO2 footprint) is preferably consumed. In a next step S4, take-up of an offset instruction is executed and, in step 5, the energy class of energy delivered is altered on the basis of the offset instruction 7. The offset instruction can be infed from external facilities. This can occur, for example, upon the execution of an offset instruction by the user. As a result, in step S5, an energy class of energy stored in the energy store 2 is altered such that, for example, undefined energy can be reclassified as green energy. In step S6, which can be executed directly after step S3 or after step S5, an information output on the energy class is delivered. In other words, in step S6, an output is delivered as to which energy, in which energy class, is stored in the energy store 2. This output can be transmitted, for example, to automated systems of carparks, toll systems, insurers, tax authorities, etc., as a result of which is it possible for third parties to ascertain an accurate footprint associated with the operation of the vehicle 10. In step S7, on the basis of the energy class of energy which is stored in the energy store 2, an output of energy control commands is delivered. Control commands can be employed to control the vehicle. In other words, in the event of the supply of green energy to the vehicle, the full driving power will be available, whereas, in the event of the supply of the vehicle with undefined energy or energy having a greater CO2 footprint, only a restricted driving power and/or functionalities of the vehicle 10 will be available. Step S7 can be executed directly after step S3, S6 or S5.

A setting function in the vehicle 10 further permits an option to the effect that charging is to be executed using green electricity only (or energy with a rating of 0 gCO2/kWh), or that a maximum upper limit on charging with electricity having a CO2 footprint is to be applied. A setting of this type can be adopted by the user, or can be preset. A display in the vehicle 10, which is similar to a milometer, totalizes the overall CO2 footprint of the totality of electricity charged, and thus indicates the CO2 load of the vehicle during an operating phase. The user can thus be continuously notified of the current size of their CO2 footprint. The actual CO2 load associated with electric charging is calculated with respect to the manufacturer of the vehicle and components thereof, rather than a flat-rate value derived from the national electricity mix. As a result, an accurate life cycle assessment for the entire vehicle, and components thereof. Moreover, taxes, assistance payments, entitlements, subsidies or similar can be calculated by reference to the charging CO2 footprint. In consequence, further incentive systems can be provided for the promotion of particularly environment-friendly electricity. Bidirectional charging of the vehicle 10 permits the re-injection of green electricity into the power grid. For example, a domestic solar installation can charge the energy store 2 during the daytime, and electricity can be fed back into the house during the night. It should be observed, in particular, that the injection of green electricity into the grid and the determination of CO2 offsetting must be possible in a demonstrable manner. It is even possible for the CO2 footprint of the vehicle 10 to be reduced as a result.

1. A method for characterizing energy stored in a vehicle, wherein the energy is delivered from an energy source to an energy store of the vehicle, the method comprising:
acquiring information on energy supplied;
processing information on the energy to establish an energy class of the energy; and
assigning the energy that is delivered to the energy store to an energy class.

2. The method according to claim 1, comprising:
taking up an offset instruction; and
altering the energy class of the energy delivered on a basis of the offset instruction.

3. The method according to claim 1, comprising:
outputting information on the energy class of the energy delivered.

4. The method according to claim 1, wherein the information on the energy includes a CO₂ footprint of the energy.

5. The method according to claim 1, comprising:
outputting control commands on a basis of the energy class of the energy delivered.

6. A charging device for delivery of energy to an energy store of a vehicle, the charging device comprising:
an input terminal for the take-up of energy from an energy source;
an output terminal for relaying the energy to an energy store; and
a control unit configured to:
control a flux of the energy;
acquire information on the energy supplied;
process information on the energy to establish an energy class of the energy; and
assign the energy that is delivered to the energy store to an energy class.

7. The charging device according to claim 6, wherein the charging device is configured for bidirectional relaying of energy.

8. The charging device according to claim 6, wherein the control unit is configured to:
control a relaying of energy on a basis of the information regarding the energy.

9. The charging device according to claim 6, wherein the control unit is configured to:
take up an offset instruction; and
alter the energy class of the energy delivered on a basis of the offset instruction.

10. The charging device according to claim 6, wherein the control unit is configured to:
output information on the energy class of the energy delivered.

11. The charging device according to claim 6, wherein the information on the energy includes a CO₂ footprint of the energy.

12. The charging device according to claim 6, wherein the control unit is configured to:
output control commands on a basis of the energy class of the energy delivered.

13. A control unit for a vehicle having an energy store, wherein the control unit is configured to:
acquire information on energy supplied;
process information on the energy to establish an energy class of the energy; and
assign the energy that is delivered to the energy store to an energy class.

14. The control unit according to claim 13, wherein the control unit is configured to:
control the vehicle on a basis of the energy class of the energy delivered to the energy store.

15. The control unit according to claim 13, wherein the control unit is configured to:
deliver an output of the energy class of the energy delivered to the energy store to a user of the vehicle.

16. The control unit according to claim 13, wherein the control unit is configured to:
take up an offset instruction; and
alter the energy class of the energy delivered on a basis of the offset instruction.

17. The control unit according to claim 13, wherein the information on the energy includes a CO₂ footprint of the energy.

18. The control unit according to claim 13, wherein the control unit is configured to:
output control commands on a basis of the energy class of the energy delivered.
